(19) United States
(12) Patent Application Publication
(10) Pub. No.: US 2011/0126794 A1
(43) Pub. Date: Jun. 2, 2011

(54) WANKEL ROTARY ENGINE

(75) Inventors: Kenji Higashi, Yamatotakada-shi (JP); Shinichi Nakasuka, Tokyo (JP); Takehiro Himeno, Tokyo (JP); Masaru Ogawa, Osaka-shi (JP); Yuuji Hori, Osaka-shi (JP); Hiroyuki Tanabe, Yamatotakada-shi (JP)

(73) Assignees: DA VINCI CO., LTD., YAMATOTAKADA-SHI, NARA (JP); THE UNIVERSITY OF TOKYO, TOKYO (JP)

(21) Appl. No.: 13/056,231

(22) PCT Filed: Jul. 29, 2009
(86) PCT No.: PCT/JP2009/063505

§ 371 Date: Jan. 27, 2011

(30) Foreign Application Priority Data
Aug. 1, 2008 (JP) 2008-199412

(51) Int. Cl. F02B 53/00

(52) U.S. Cl. 123/241

(57) ABSTRACT

A roller 58 is rotatably held by an end portion of an eccentric support roller shaft 50 so that the roller 58 contacts with an inner periphery circular side surface of a rotor 40. Accordingly, a rotational resistance while the rotor 40 is eccentrically rotated can be decreased in comparison with a configuration in which an internal gear formed in an inner periphery of a rotor and an external gear formed in an eccentric shaft interlock each other. Thus, the rotating shaft 52 can be efficiently driven to rotate when a pressure difference is small and energy for rotating the roller 58 is small.

### TECHNICAL FIELD

The present invention relates to a wankel rotary engine, in particular to a wankel rotary engine that includes a housing having a fluid intake port that takes in a working fluid of a first pressure and a fluid exhaust port that exhausts the working fluid by means of a second pressure or a back pressure lower than the first pressure; and rotor housed in the housing, and rotatably drives the rotor based on a pressure difference between the first pressure and the second pressure.

### BACKGROUND ART

Conventionally, there is a proposed wankel rotary engine that takes out a rotational power from a rotor by means of an interlock between internal gear formed in an inner periphery of the rotor and an external gear formed in an eccentric shaft (for example, refer to Patent Documents 1 and 2). Further, there is a proposed wankel rotary engine that includes two intake ports and two exhaust ports in a housing (for example, refer to Patent Document 3).

### PRIOR ART DOCUMENTS

### Patent Documents

[Patent Document 1] Japanese Patent Application Laid-Open No. 2004-263682
[Patent Document 2] Japanese Patent Application Laid-Open No. Hey 3-100301
[Patent Document 3] Japanese Patent Application Laid-Open No. Sho 61-40421

### DISCLOSURE OF THE INVENTION

When the above-described wankel rotary engines are operated as an internal combustion engine, the engines can rotate the rotor by means of explosive energy. When rotating the rotor by means of a pressure difference of a working fluid, however, the rotor may not overcome an initial resistance due to a backlash with respect to the interlock between the gears and not rotate under a condition where the pressure difference is small and energy for rotating the rotor is small. Even if the rotor rotates by means of the pressure difference in such a condition, energy efficiency may be deteriorated since energy loss in the rotation becomes large.

The wankel rotary engine according to the present invention have an object to efficiently rotate a rotor to take out a rotational power when energy for rotating the rotor is small.

The present invention accomplishes the demand mentioned above by the following configurations applied to a wankel rotary engine.

A wankel rotary engine according to the invention is a wankel rotary engine that includes a housing having a fluid intake port to take in a working fluid of a first pressure and a fluid exhaust port to exhaust the working fluid by means of a second pressure or a back pressure lower than the first pressure; and rotor housed in the housing, and rotatably drives the rotor based on a pressure difference between the first pressure and the second pressure. The wankel rotary engine includes an eccentric member that rotates together with a rotating support shaft rotatably supported around a center of the housing and is attached to the rotating support shaft so as to make the rotating support shaft eccentric with respect to a central cylindrical hole formed inside of the rotor as a cylindrical through hole coaxial with a central axis of the rotor; and a rotating member that is attached to at least one of an inner periphery surface of the central cylindrical hole and a closest portion of the eccentric member located closest to the inner periphery surface of the central cylindrical hole, and is interposed between the inner periphery surface of the central cylindrical hole and the closest portion.

In the wankel rotary engine according to the invention, the rotating member is attached to at least one of the inner periphery surface of the central cylindrical hole and the closest portion of the eccentric member located closest to the inner periphery surface of the central cylindrical hole, and is interposed between the inner periphery surface of the central cylindrical hole and the closest portion. The rotating member rotates in response to the rotation of the rotor so as to decrease a sliding resistance between the inner periphery surface of the central cylindrical hole and the closest portion of the eccentric member. Thus, the rotor can be efficiently rotated to take out the rotational power when energy for rotating the rotor is small.

In the wankel rotary engine according to the invention, the rotating member may be a roller that is axially supported by the closest portion of the eccentric member and rotates while contacting with the inner periphery surface of the central cylindrical hole in response to a rotation of the rotor. In the wankel rotary engine, the rotation of the roller can advantageously decrease the sliding resistance between the inner periphery surface of the central cylindrical hole and the closest portion of the eccentric member.

In the wankel rotary engine according to the invention, the rotating member may be a ball bearing that holds a plurality of balls in conjunction with the inner periphery surface of the central cylindrical hole so as to rotatably hold or guide the eccentric member with respect to the central cylindrical hole. In the wankel rotary engine, the ball bearing can advantageously decrease the sliding resistance between the inner periphery surface of the central cylindrical hole and the closest portion of the eccentric member.

In the wankel rotary engine according to the invention, the central cylindrical hole may include a plurality of depressed portions that are uniformly spaced in the inner periphery surface thereof and respectively have a semicircular cross-section, and the eccentric member may include a cylindrical member having the rotating support shaft as a central axis; and a plurality of rollers or balls that are rotatably supported by an outer periphery portion of the cylindrical member. The respective roller or ball may be sequentially engaged with a corresponding one of the plurality of depressed portions of the central cylindrical hole in response to a rotation of the cylindrical member. This configuration decreases a rotational resistance in comparison with a wankel rotary engine with an eccentric shaft and allows a torque transmission as is the case with the eccentric shaft.

In the wankel rotary engine according to the invention, two fluid intake ports and two fluid exhaust ports may be formed in vicinities of flat top portions of a side portion of the housing so that the two fluid intake ports are symmetric with respect to the rotating support shaft and the two fluid exhaust ports are symmetric with respect to the rotating support shaft. This configuration allows effective use of a hollow chamber between the housing and the rotor, so that a high-efficiency rotary engine can be achieved. Here, “vicinities of flat top portions” may include vicinities of top portions of a front face or a back face of the housing in addition to the vicinities of top portions of the side portion of the housing.

In the wankel rotary engine according to the invention, the working fluid may exist in gaseous form where temperature is equal to or higher than a first temperature under the first pressure and exist in liquid form where temperature is lower than a second temperature lower than the first temperature under the second pressure. The fluid intake port and the fluid exhaust port may be connected through a circulation passage that circulates the working fluid. The circulation passage may include a heating section that heats the working fluid in the vicinity of the fluid intake port and a cooling section that cools the working fluid in the vicinity of the fluid exhaust port. Thus, the wankel rotary engine can be operated as a heat engine utilizing a single working fluid.

### BRIEF DESCRIPTION OF THE DRAWINGS

FIG. 1 is a schematic view of a wankel rotary engine 20 according one embodiment of the present invention;

FIG. 2 is an exploded perspective view of a rotor 40;

FIG. 3 is an exploded perspective view of an eccentric support roller shaft 50;

FIG. 4A, FIG. 4B, FIG. 4C and FIG. 4D are views illustrating rotational changes of the wankel rotary engine 20 of the embodiment rotated by 120 degrees.

FIG. 5 is a block diagram of an example of the wankel rotary engine 20 according to the embodiment configured as a heat engine;

FIG. 6 is a schematic view of a wankel rotary engine 20B according to a modification of the present invention; and

FIG. 7 is a schematic view of a wankel rotary engine 20C according to another modification of the present invention.

### MODES OF CARRYING OUT THE INVENTION

Now, the mode for carrying out the present invention will be described with reference to an embodiment.

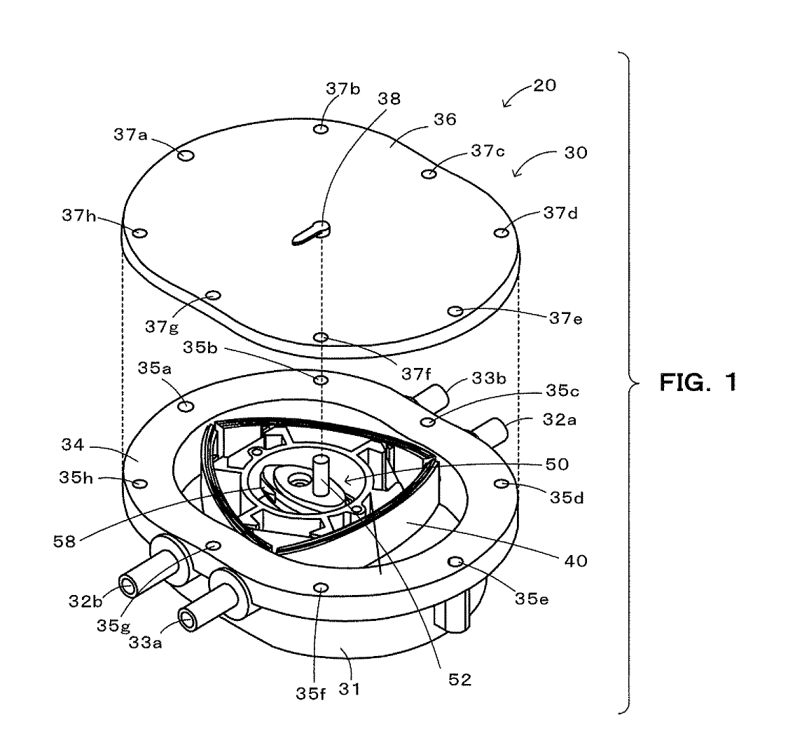

FIG. 1 is a schematic view of a wankel rotary engine 20 according one embodiment of the present invention. As shown in FIG. 1, the wankel rotary engine 20 of the embodiment includes a housing 30 having a lower housing 31 and a upper cover 36 of aluminum, a rotor 40 of the aluminum that is housed in the housing 30 and an eccentric support roller shaft 50 that rotates in response to a rotation of the rotor 40.

The lower housing 31 configuring the housing 30 has an inner side surface formed as two-node peritrochoid surface (cocoon shape), and two fluid intake ports 32a and 32b and two fluid exhaust ports 33a and 33b are formed in vicinities of flat top portions of a side portion of the lower housing 31 so that the two fluid intake ports 32a and 32b are symmetric with respect to a center of the lower housing 31 and the two fluid exhaust ports 33a and 33b are symmetric with respect to the center of the lower housing 31. A flange 34 is formed in a upper portion of the lower housing 31 and eight through holes 35a-35h are formed in the flange 34 so as to attach the upper cover 36 thereon by bolts (not shown). A support hole (not shown) that rotatably supports a rotating shaft 52 of the eccentric support roller shaft 50 is formed in a central bottom portion of the lower housing 31. Eight through holes 37a-37h are formed in the upper cover 36 configuring the housing 30 so as to align with the eight through holes 35a-35h of the flange 34 and a through hole (not shown) through which the rotating shaft 52 of the eccentric support roller shaft 50 passes is formed in a center of the lower housing 31. In FIG. 1, a rotation mark 38 for a visual observation is attached to the rotating shaft 52.

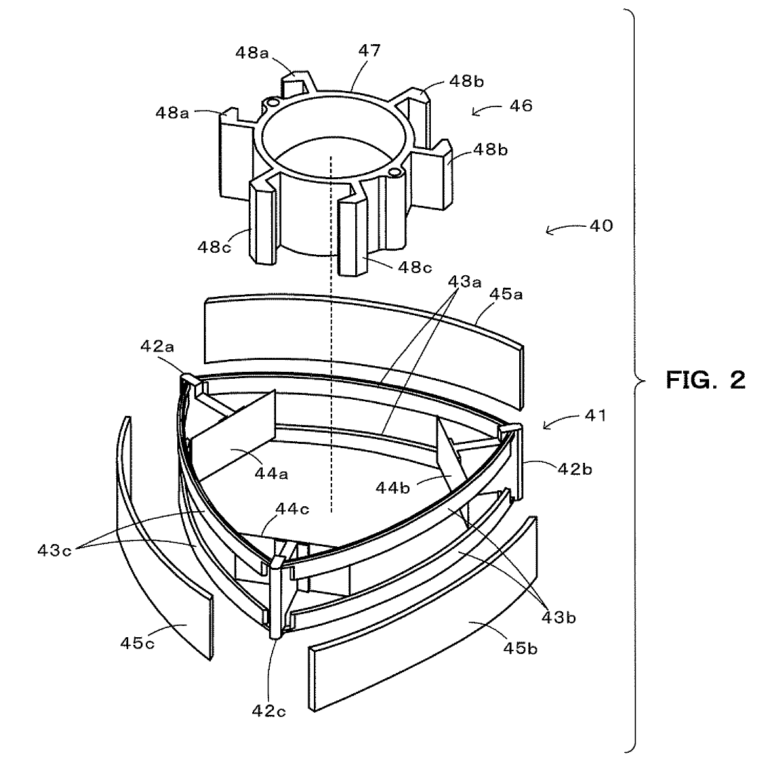

The rotor 40 has a three-lobed shape (triangular shape) configured by three envelope and is inscribed in the inner periphery side surface of the lower housing 31. As shown in an exploded perspective view of FIG. 2, the rotor 40 includes a rotor frame 41 made of the aluminum and formed in a triangular shape, three rotor outer walls 45a-45c made of the aluminum and attached to a corresponding side of the rotor frame 41, and an inner periphery circular member 46 made of the aluminum and attached to an inside of rotor frame 41. The rotor frame 41 has side surface sliding seals 42a-42c respectively contact with the inner periphery side surface of the lower housing 31 to seal off therebetween and respectively define three vertices of the top of the rotor frame 41, flat springs 44a-44c respectively contact with an end portion of corresponding side surface sliding seal 42a, 42b or 42c so as to apply an outwardly urging force to the corresponding one, and frame members 43a-43c respectively formed as a frame element for hanging the side surface sliding seal 42a, 42b or 42c. The inner periphery circular member 46 is configured by providing a cylindrical portion 47 having a cylindrical shape with three sets of leg portions 48a-48c for urging the flat springs 44a-44c. The cylindrical portion 47 is disposed within the rotor frame 41 so that the three sets of the leg portions 48a-48c align with corresponding flat springs 44a-44c. Thus, each of the side surface sliding seals 42a-42c is subjected to the outwardly urging force and contacts with the inner periphery side surface of the lower housing 31 with a slight urging force when the rotor 40 is housed in the lower housing 31.

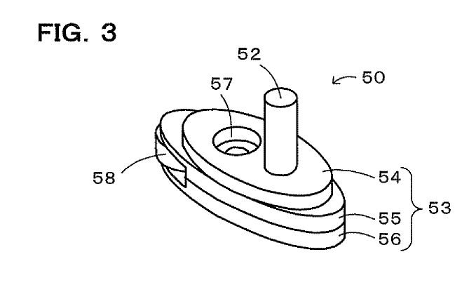

As shown in FIG. 3, the eccentric support roller shaft 50 includes the rotating shaft 52 made of the aluminum, an eccentric member 53 made of the aluminum and formed in an ellipse shape so as to eccentrically hold the rotating shaft 52, and a roller 58 made of the aluminum and attached to an end portion distal from the rotating shaft 52 of the eccentric member 53. The eccentric member 53 has roller holding members 55 and 56 formed to rotatably hold the roller 58 from an upper side and a lower side and have a longest diameter slightly smaller than a diameter of an inner periphery circle in the inner periphery circular member 46 of the rotor 40, and a rotating shaft holding member 54 that is formed in an ellipse shape having a longest diameter shorter than the longest diameter of the roller holding members 55 and 56 and holds the rotating shaft 52 together with the roller holding members 55 and 56.

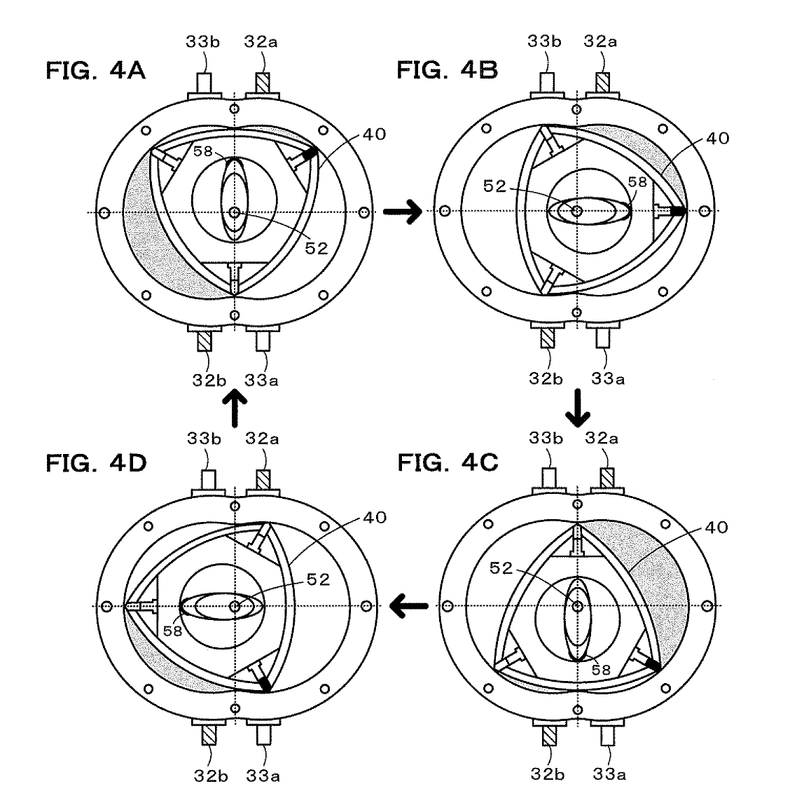

Next, the operation of the wankel rotary engine 20 with the above configuration will be described. FIG. 4A, FIG. 4B, FIG. 4C and FIG. 4D are views illustrating rotational changes of the wankel rotary engine 20 of the embodiment rotated by 120 degrees. In the figures, a contact portion of one of the side surface sliding seals 42a-42c is filled in with black so as to make it easier to understand the rotation. In the embodiment, it is assumed that the fluid intake ports 32a and 32b are connected with an accumulator (not shown) in which a working fluid (an alcohol in gaseous form, for example) is held at a first pressure (pressure slightly above atmospheric pressure) and the fluid exhaust ports 33a and 33b are connected with an accumulator (not shown) in which the working fluid is held at a second pressure (pressure slightly below atmospheric pressure) smaller that the first pressure. In FIG. 4A, the first pressure is supplied to the fluid intake ports 32a and 32b and the second pressure is supplied to the fluid exhaust ports 33a and 33b. Thus, according to a pressure difference between the first pressure and the second pressure, the working fluid flows into the fluid intake ports 32a and 32b and flows out from the fluid exhaust ports 33a and 33b. Accordingly, the rotor 40 is rotated in a clockwise direction in the figure. At this time, the rotor 40 is eccentrically rotated since the rotating shaft 52 is eccentrically held by the eccentric support roller shaft 50. The roller 58 of the eccentric support roller shaft 50 contacts with an inner periphery circular side surface of the inner periphery circular member 46 of the rotor 40, so that a rotational resistance of the rotor 40 is decreased by a rotation of the roller 58. The side surface sliding seals 42a-42c are outwardly urged by the flat springs 44a-44c, so that the rotor 40 rotates and brings the side surface sliding seals 42a-42c into intimate contact with the inner periphery side surface of the lower housing 31. Accordingly, a hollow chamber defined by the housing 30 and the rotor 40 is hermetically sealed, so that the working fluid does not leak out into other hollow chambers. Thus, it is possible to convert the pressure difference into a rotational power. When the rotor 40 rotates by 30 degrees and shifts from a state in FIG. 4A to a state in FIG. 4B, an inflow of the working fluid into the fluid intake port 32b and an exhaust of the working fluid from the fluid exhaust port 33b are temporarily stopped. However, the first pressure is still supplied to the fluid intake port 32a and the second pressure is still supplied to the fluid exhaust port 33a. Thus, according to the pressure difference, the working fluid flows into the fluid intake port 32a and flows out from the fluid exhaust port 33a. Accordingly, the rotor 40 is rotated in the clockwise direction. At this time, the eccentric support roller shaft 50 rotates by 90 degrees in comparison with the state in FIG. 4A. When the rotor 40 further rotates by 30 degrees and shifts to a state in FIG. 4C that is inverse with respect to the state in FIG. 4A, the first pressure is supplied to the fluid intake ports 32a and 32b and the second pressure is supplied to the fluid exhaust ports 33a and 33b. Thus, according to the pressure, the working fluid flows into the fluid intake ports 32a and 32b and flows out from the fluid exhaust ports 33a and 33b. Accordingly, the rotor 40 is rotated in the clockwise direction. At this time, the eccentric support roller shaft 50 rotates by 180 degrees in comparison with the state in FIG. 4A. When the rotor 40 further rotates by 30 degrees and shifts to a state in FIG. 4D that is inverse with respect to the state in FIG. 4B, an inflow of the working fluid into the fluid intake port 32a and an exhaust of the working fluid from the fluid exhaust port 33a are temporarily stopped. However, the first pressure is still supplied to the fluid intake port 32b and the second pressure is still supplied to the fluid exhaust port 33b. Thus, according to the pressure difference, the working fluid flows into the fluid intake port 32b and flows out from the fluid exhaust port 33b. Accordingly, the rotor 40 is rotated in the clockwise direction. The eccentric support roller shaft 50 rotates by 270 degrees in comparison with the state in FIG. 4A. When the rotor 40 further rotates by 30 degrees, the rotor 40 eventually rotates by 120 degrees and shifts to the state in FIG. 4A. The eccentric support roller shaft 50 rotates by 360. Thus, in the wankel rotary engine 20 of the embodiment, the rotating shaft 52 rotates three times every one rotation of the rotor 40.

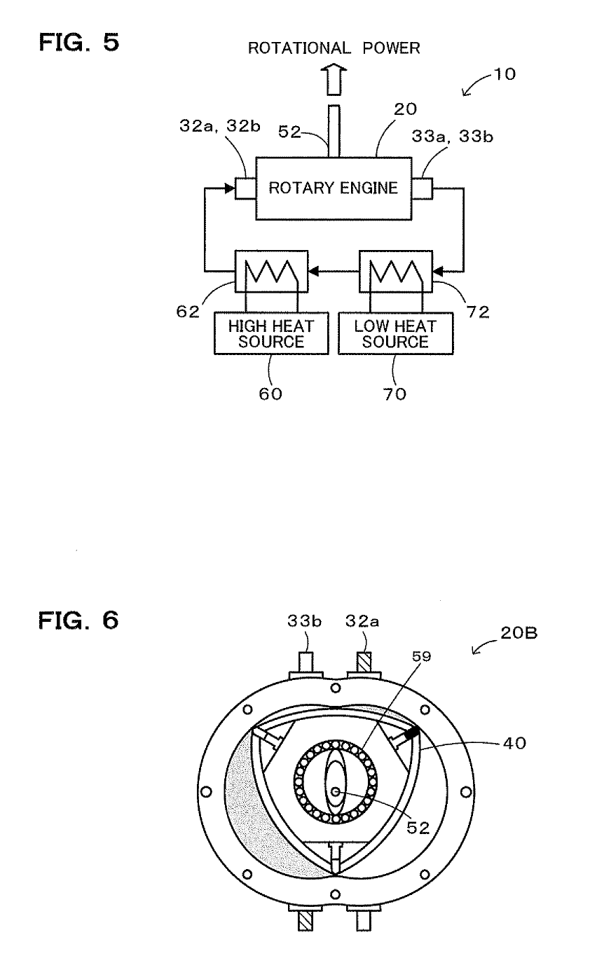

FIG. 5 is a block diagram of an example of the wankel rotary engine 20 according to the embodiment configured as a heat engine. The heat engine includes the wankel rotary engine 20 of the embodiment, a heat exchanger 62 that vaporizes the working fluid in the side of the fluid intake ports 32a and 32b of a circulation passage circulating the working fluid through the fluid intake ports 32a, 33b and the fluid exhaust ports 33a, 33b by high heat from a high heat source 60, and a heat exchanger 72 that liquefies the working fluid in the side of the fluid exhaust ports 33a and 32b by cool heat from a low heat source 70. In the heat engine, the working fluid in the side of the fluid intake ports 32a and 32b vaporizes and has a high pressure and the working fluid in the side of the fluid exhaust ports 33a and 33b liquefies and has a low pressure. Accordingly, the rotor 40 of the wankel rotary engine 20 rotates as described above, so that the rotational power can be taken out from the rotational shaft 52.

As has been described above, in the wankel rotary engine 20 of the embodiment, the roller 58 is rotatably held by the end portion of the eccentric support roller shaft 50 so that the roller 58 contacts with the inner periphery circular side surface of the inner periphery circular member 46 of the rotor 40. Accordingly, the rotational resistance while the rotor 40 is eccentrically rotated can be decreased in comparison with the wankel rotary engine in which the internal gear formed in the inner periphery of the rotor and the external gear formed in the eccentric shaft interlock each other. As a result, the rotating shaft 52 can be efficiently driven to rotate when the pressure difference is small and energy for rotating the roller 58 is small. Thus, the wankel rotary engine 20 of the embodiment can be used as the heat engine so as to efficiently convert heat energy to rotational energy.

In the wankel rotary engine 20 of the embodiment, the roller 58 is rotatably held by the end portion of the eccentric support roller shaft 50 so that the roller 58 contacts with the inner periphery circular side surface of the inner periphery circular member 46 of the rotor 40. Instead of the roller 58, a ball bearing 59 may be attached to an inner periphery surface of a rotor and an end portion of an eccentric support shaft as in a wankel rotary engine 20B of a modification shown in FIG. 6. Thus, as is the case with the wankel rotary engine having the roller 58 rotatably held by the end portion of the eccentric support roller shaft 50, the rotational resistance while the rotor is eccentrically rotated can be decreased in comparison with the wankel rotary engine in which the internal gear formed in the inner periphery of the rotor and the external gear formed in the eccentric shaft interlock each other.

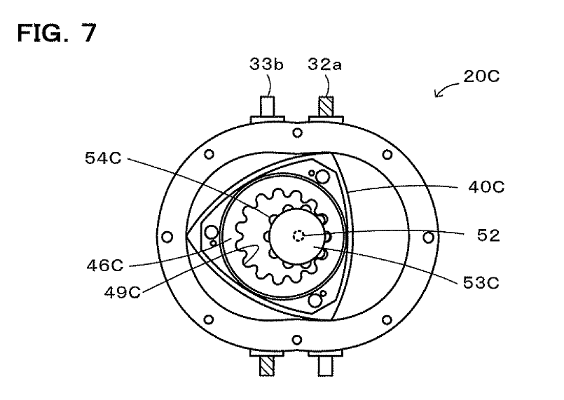

In the wankel rotary engine 20 of the embodiment, the roller 58 is rotatably held by the end portion of the eccentric support roller shaft 50 so that the roller 58 contacts with the inner periphery circular side surface of the inner periphery circular member 46 of the rotor 40. Alternatively, a wankel rotary engine 20C of a modification shown in FIG. 7 includes an inner periphery circular member 46C having a plurality of depressed portions 49C that are uniformly spaced in an inner periphery circular side surface and respectively have a semicircular cross-section, and a cylindrical member 53C that is attached to the rotating shaft 52 and rotatably holds a plurality of rollers 54C in an outer periphery thereof so that the respective roller 54C is sequentially engaged with the corresponding one of the plurality of depressed portions 49c of the inner periphery circular member 46C in response to a rotation of a rotor 40C. In the modification, the respective roller 54C rotatably held by the cylindrical member 53C is sequentially engaged with the corresponding one of the plurality of depressed portions 49c of the inner periphery circular member 46C in response to a rotation of a rotor 40C. The rollers 54C rotate when they engage with the depressed portion 49C or disengage from the depressed portion 49C, so that a rotational resistance of the rotor 40C can be decreased in comparison with the wankel rotary engine with the eccentric shaft and a torque transmission as is the case with the eccentric shaft can be achieved. In the wankel rotary engine 20C of the modification, the cylindrical member 53C may hold rotatable members having other shape than the roller such as a plurality of balls instead of the plurality of rollers 54C.

As described above with reference to FIG. 5, the wankel rotary engine 20 of the embodiment can be operated as the heat engine. In the heat engine, it is essential only that the pressure difference exists between the working fluid supplied to the fluid intake ports 32a and 32b and the working fluid supplied to the fluid exhaust ports 33a and 33b. Accordingly, any other configurations can be used to ensure the pressure difference between the working fluid supplied to the fluid intake ports 32a and 32b and the working fluid supplied to the fluid exhaust ports 33a and 33b instead of the high and low heat sources.

The wankel rotary engine 20 may include one fluid intake port and one fluid exhaust port instead of the two fluid intake ports 32a and 32b and two fluid exhaust ports 33a and 33b formed in the lower housing 31 of the housing 30.

In the wankel rotary engine 20 of the embodiment, the housing 30, the rotor 40, the eccentric support roller shaft 50 may be made of other metals, alloys, plastics and the like instead of the aluminum.

The wankel rotary engine 20 may be designed to consume any working fluid other than the alcohol.

Hereinbefore, the present invention have been described with reference to embodiments, however, the present invention is not limited to the above embodiments. It will be apparent that various modifications can be made to the present invention without departing from the spirit and scope of the present invention.

### INDUSTRIAL APPLICABILITY

The present invention can be used in a manufacturing industry or the like of the wankel rotary engine.

1. A wankel rotary engine that includes a housing having a fluid intake port to take in a working fluid of a first pressure and a fluid exhaust port to exhaust the working fluid by means of a second pressure or a back pressure lower than the first pressure; and rotor housed in the housing, and rotatably drives the rotor based on a pressure difference between the first pressure and the second pressure, the wankel rotary engine comprising:
an eccentric member that rotates together with a rotating support shaft rotatably supported around a center of the housing and is attached to the rotating support shaft so as to make the rotating support shaft eccentric with respect to a central cylindrical hole formed inside of the rotor as a cylindrical through hole coaxial with a central axis of the rotor; and
a rotating member that is attached to at least one of an inner periphery surface of the central cylindrical hole and a closest portion of the eccentric member located closest to the inner periphery surface of the central cylindrical hole, and is interposed between the inner periphery surface of the central cylindrical hole and the closest portion.

2. A wankel rotary engine according to claim 1, wherein the rotating member is a roller that is axially supported by the closest portion of the eccentric member and rotates while contacting with the inner periphery surface of the central cylindrical hole in response to a rotation of the rotor.

3. A wankel rotary engine according to claim 1, wherein the rotating member is a ball bearing that holds a plurality of balls in conjunction with the inner periphery surface of the central cylindrical hole so as to rotatably hold or guide the eccentric member with respect to the central cylindrical hole.

4. A wankel rotary engine according to claim 1, wherein the central cylindrical hole includes a plurality of depressed portions that are uniformly spaced in the inner periphery surface thereof and respectively have a semicircular cross-section, and wherein the eccentric member includes a cylindrical member having the rotating support shaft as a central axis; and a plurality of rollers or balls that are rotatably supported by an outer periphery portion of the cylindrical member, the respective roller or ball being sequentially engaged with a corresponding one of the plurality of depressed portions of the central cylindrical hole in response to a rotation of the cylindrical member.

5. A wankel rotary engine according to claim 1, wherein two fluid intake ports and two fluid exhaust ports are formed in vicinities of flat top portions of a side portion of the housing so that the two fluid intake ports are symmetric with respect to the rotating support shaft and the two fluid exhaust ports are symmetric with respect to the rotating support shaft.

6. A wankel rotary engine according to claim 1, wherein the working fluid exists in gaseous form where temperature is equal to or higher than a first temperature under the first pressure and exists in liquid form where temperature is lower than a second temperature lower than the first temperature under the second pressure, wherein the fluid intake port and the fluid exhaust port are connected through a circulation passage that circulates the working fluid, and wherein the circulation passage includes a heating section that heats the working fluid in the vicinity of the fluid intake port and a cooling section that cools the working fluid in the vicinity of the fluid exhaust port.
